(19) United States
(12) Patent Application Publication
(10) Pub. No.: US 2026/0140356 A1
(43) Pub. Date: May 21, 2026

(54) SCANNING-TYPE OBSERVATION APPARATUS

(71) Applicant: CANON KABUSHIKI KAISHA, Tokyo (JP)

(72) Inventor: MAKOTO KAWAGUCHI, Kanagawa (JP)

(21) Appl. No.: 19/391,294

(22) Filed: Nov. 17, 2025

(30) Foreign Application Priority Data
Nov. 19, 2024 (JP) 2024-201550

(51) Int. Cl. G02B 21/00; G02B 21/14; G02B 21/18

(52) U.S. Cl. CPC G02B 21/0056; G02B 21/0032; G02B 21/0084; G02B 21/14; G02B 21/18

(57) ABSTRACT

A scanning-type observation apparatus includes a first emission optical system which emits first light, a second emission optical system which emits second light, a wave combining unit which wave-combines the first light and the second light, a scanning unit which synchronously scans the first light and the second light wave-combined, a first objective lens which condenses each of the scanned first light and second light scanned, a placement unit which allows a specimen to be placed at a light condensing position of the first objective lens, a second objective lens which captures secondary light from the specimen, and a detection unit which detects the secondary light, separates a signal received from the detection unit into a first signal corresponding to a non-linear photothermal effect and a second signal which does not contain the non-linear photothermal effect, and performs imaging based on at least one of the first and second signals.

### BACKGROUND

### Field of the Technology

The present disclosure relates to a scanning-type observation apparatus.

### Description of the Related Art

Recently, in the fields of, for example, regeneration medicine, intraoperative rapid diagnosis, and biological production, there have been growing expectations for a method of observing or evaluating live cells without staining and without contact. Examples of a method of imaging live cells without staining and without contact include detecting a phase difference of light having passed through the cell and detecting Raman scattering light occurring due to the vibration of molecules constituting the cells.

Japanese Patent Laid-Open No. 2019-35859 describes an apparatus capable of performing live cell observation using both phase-contrast imaging to detect a phase difference as the intensity of light and a Coherent anti-Stokes Raman scattering (CARS) imaging method to detect anti-Stokes Raman scattering light occurring by a non-linear optical effect.

In the apparatus described in Japanese Patent Laid-Open No. 2019-35859, while a phase contrast image is obtained by illuminating the entire observation area at one time and then performing imaging of the observation area with a charge-coupled device (CCD) camera, a CARS image is obtained by condensing illumination light to one point of the observation area and performing scanning of the condensed illumination light. Thus, the apparatus uses different image forming measures with the respective different imaging methods. Therefore, primary images which are obtained by the respective imaging methods differ in observation areas or in the number of pixels, so that the image qualities thereof are not consistent. Therefore, to make the image qualities thereof consistent, it is necessary for the operator to perform a preliminarily calibration of the apparatus or post-processing of the images, which is cumbersome for the operator. In this way, it has been required to reduce the burden on the operator who wants to observe live cells by a plurality of methods.

### SUMMARY

The present disclosure is directed to providing a scanning-type observation apparatus capable of easily obtaining consistency of a phase-difference image and a Raman image.

According to an aspect of the present disclosure, a scanning-type observation apparatus includes a first emission optical system configured to emit first light including a spatially modulated component, a second emission optical system configured to emit second light coherently and temporally modulated, a wave combining unit configured to wave-combine the first light and the second light, a scanning unit configured to synchronously scan the first light and the second light which have been wave-combined, a condensing lens configured to condense each of the first light and the second light which have been scanned, a placement unit configured to allow a specimen to be placed at a light condensing position of the condensing lens, a light capturing lens located on a side opposite to the condensing lens across the placement unit and configured to capture secondary light received from the specimen, a detection unit configured to detect the secondary light captured by the light capturing lens, a separation unit configured to temporally demodulate a signal received from the detection unit and to separate the demodulated signal into a first signal corresponding to a non-linear photothermal effect having occurred at the specimen by irradiation of the second light and a second signal which does not contain the non-linear photothermal effect, and an image generation unit configured to generate an image based on scan information concerning the scanning unit and at least one of the first signal and the second signal.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an outline of a connection relationship of elements which constitute a scanning-type observation apparatus according to a first embodiment of the present disclosure.

FIG. 2 is a schematic diagram illustrating a configuration of the scanning-type observation apparatus according to the first embodiment.

FIG. 3 is a schematic diagram illustrating a phase-difference observation system of the scanning-type observation apparatus according to the first embodiment.

FIG. 4 is a schematic diagram illustrating a stimulated Raman photothermal (SRP) induction system of the scanning-type observation apparatus according to the first embodiment.

FIGS. 5A, 5B, and 5C are schematic diagrams used to explain light irradiation timing of the scanning-type observation apparatus according to the first embodiment with regard to a plurality of cycles of measurement (FIG. 5A) and one cycle of measurement (FIGS. 5B and 5C).

FIG. 6 is a diagram used to explain a method of generating an SRP image and a phase-difference image.

FIGS. 7A, 7B, and 7C are diagrams illustrating examples of an observation processing flow using the scanning-type observation apparatus according to the first embodiment (FIG. 7A), a relationship between a region of interest and an observation field of view (FIG. 7B), and an outline configuration of a scan condition determination unit (FIG. 7C).

FIG. 8 is a schematic diagram illustrating a configuration of a scanning-type observation apparatus according to a second embodiment of the present disclosure.

FIGS. 9A and 9B are schematic diagrams used to explain a relationship between a phase plate included in a phase-difference detection unit and a set of transmitted light fluxes according to the second embodiment.

FIG. 10 is a schematic diagram illustrating a configuration of a scanning-type observation apparatus according to a third embodiment of the present disclosure.

FIG. 11 is a schematic diagram illustrating a configuration of a scanning-type observation apparatus according to a fourth embodiment of the present disclosure.

FIG. 12 is a diagram illustrating an observation processing flow using the scanning-type observation apparatus according to the fourth embodiment.

### DESCRIPTION OF THE EMBODIMENTS

Various embodiments, features, and aspects of the present disclosure will be described in detail below with reference to the drawings.

### First Embodiment

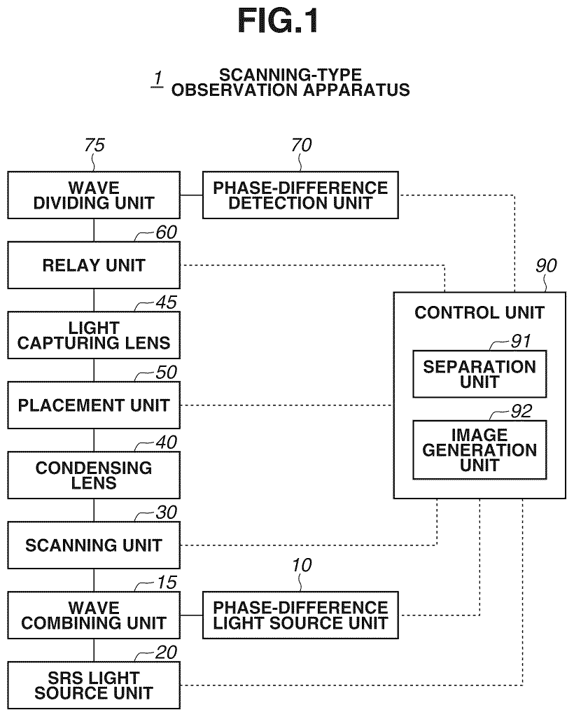

A configuration of a scanning-type observation apparatus according to a first embodiment of the present disclosure is described with reference to FIG. 1 to FIG. 4.

The scanning-type observation apparatus 1 according to the first embodiment acquires a Raman signal by detecting a stimulated Raman photothermal (SRP) effect using a phase difference. The Raman signal may be reworded as an “SRP signal”. A plot representing the wavelength dependency of an SRP signal intensity (in some cases, referred to simply as an “SRP intensity” is referred to as an “SRP spectrum”, and an image obtained by mapping a two-dimensional or three-dimensional spatial distribution of the SRP signal intensity is referred to as an “SRP image”. The SRP spectrum and the SRP image may be reworded as a “Raman spectrum” and a “Raman image”, respectively. The stimulated Raman photothermal effect is a phenomenon in which the refractive index of a medium changes due to heat occurring by a molecular vibrational relaxation accompanied by stimulated Raman scattering (SRS).

(Yifan Zhu et al., Stimulated Raman photothermal microscopy toward ultrasensitive chemical imaging. Sci. Adv. 9, eadi2181 (2023).)

FIG. 1 is a block diagram illustrating an outline of a connection relationship of elements which constitute the scanning-type observation apparatus 1. In FIG. 1, a solid line used for connection between blocks (rectangles) represents an optical connection for the corresponding constituent elements, and a dashed line used for connection between blocks (rectangles) represents there being a connection capable of transmitting signals concerning measurement or control between the corresponding constituent elements.

The scanning-type observation apparatus 1 includes a first emission optical system 10 (phase-difference light source unit), a second emission optical system 20 (SRS light source unit), a wave combining unit 15, a scanning unit 30, a first objective lens 40 (condensing lens), and a placement unit 50, which are optically interconnected. The scanning-type observation apparatus 1 further includes a second objective lens 45 (light capturing lens), a relay unit 60, a wave dividing unit 75, and a first detection unit 70 (phase-difference detection unit). Additionally, the scanning-type observation apparatus 1 includes a control unit 90. The control unit 90 is connected to the first emission optical system 10 (phase-difference light source unit), the second emission optical system 20 (SRS light source unit), the scanning unit 30, the placement unit 50, the relay unit 60, and the first detection unit 70 (phase-difference detection unit) in such a way as to be able to communicate with them or in such a way as to be able to control them.

In the scanning-type observation apparatus 1, the first emission optical system 10 (phase-difference light source unit) forms a first emission optical system, and the second emission optical system 20 (SRS light source unit) forms a second emission optical system.

Moreover, the first detection unit 70 (phase-difference detection unit) forms a first detection unit. Furthermore, the scanning-type observation apparatus may be reworded as an “observation apparatus”, a “scanner”, a “microscope”, or a “microscopic observation apparatus”, and the scanning-type may be reworded as “point scanning-type” or “spot scanning-type”.

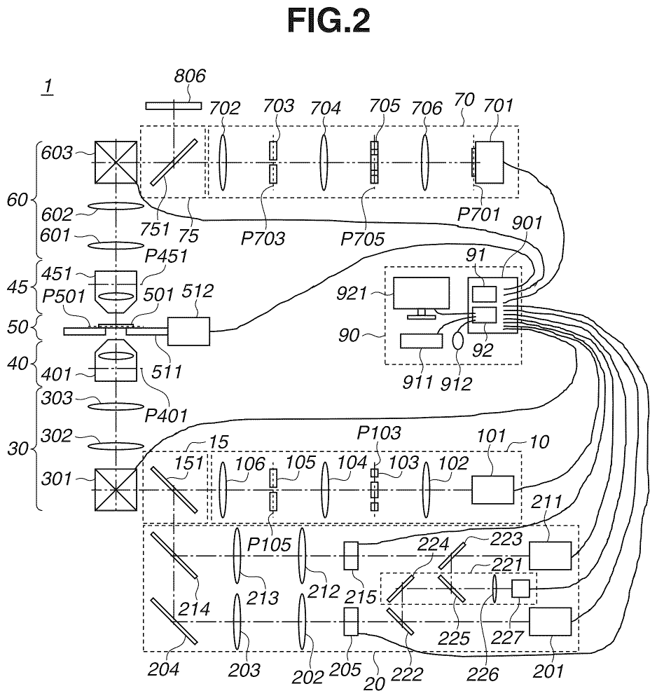

FIG. 2 is a schematic diagram illustrating a configuration of the scanning-type observation apparatus 1 according to the first embodiment.

### [Placement Unit]

The placement unit 50 includes a stage 511 and a stage scanner 512. The stage 511 supports a specimen 501, which is an observation object for the scanning-type observation apparatus 1, in such a manner that the light condensing position of the first objective lens 40 and at least one of the specimen 501 overlap each other. The placement unit 50 may be reworded as a “supporting unit 50 for the specimen 501” or a “specimen stage 50”. Moreover, the light condensing position of the first objective lens 40 may be reworded as, for example, a “focus of the first objective lens 40” or a “light condensing point of the first objective lens 40”.

The stage 511 includes a portion optically opened in such a way as to allow entrance of primary light and exit of secondary light with respect to the specimen 501. The opened portion to be employed can be either a form closed in a circumferential direction or a form not closed in circumferential direction.

This configuration allows light coming from the first objective lens 40 to be radiated onto the specimen 501 placed on the stage 511. The stage scanner 512 is coupled to the stage 511. The stage scanner 512 moves the stage 511 in parallel with a surface with the specimen 501 placed thereon. This enables the operator to, after placing the specimen 501, readily move a portion of the specimen 501 which the operator wants to observe to an observation area of the scanning-type observation apparatus 1. Moreover, the stage scanner 512 moves the stage 511 perpendicularly to the surface with the specimen 501 placed thereon.

This enables the operator to easily perform focusing on the specimen 501 and three-dimensionally observe the specimen 501.

### [First Objective Lens and Second Objective Lens]

The first objective lens 40 and the second objective lens 45 include objective lenses 401 and 451, respectively. The objective lenses 401 and 451 are arranged on mutually opposite sides with respect to the stage 511. The objective lenses 401 and 451 are arranged in such a way as to share a focal plane P501. The focal plane P501 may be reworded as a “specimen plane P501”. Moreover, the objective lenses 401 and 451 may be reworded as “lenses having portions the depths of focus of which overlap each other in the optical axis direction”.

The focal plane P501 may be reworded as a “plane included in the portions the depths of which overlap each other”. In this case, the pupil planes P401 and P451 of the objective lenses 401 and 451 are in a conjugate positional relationship.

This enables preventing or reducing artifacts being superimposed on a phase-difference signal, SRP image, or SRP spectrum to be acquired or the detection sensitivity thereof being decreased. With regard to the objective lenses 401 and 451, it is desirable that the axial and off-axis focuses thereof become the same in either waveform from a visible range to a near-infrared range. Accordingly, it is desirable that axial chromatic aberration and chromatic aberration of magnification be preliminarily sufficiently corrected. This enables preventing or reducing a decrease in the detection sensitivity for an SRP signal. The objective lens 401 and the objective lens 451 may be reworded as a “light condensing lens 401” and a “light capturing lens 451” respectively.

### [Phase-Difference Light Source Unit]

The first emission optical system 10 (phase-difference light source unit) includes a light-emitting diode (LED) 101, a collimator 102, a ring slit 103, relay lenses 104 and 106, and a pinhole 105. The LED 101 emits incoherent light with a predetermined waveform. The LED 101 emits light with a predetermined waveform in a visible light range. It is desirable that the LED 101 can be regarded as a point light source. For example, the LED 101 can be optically coupled to one end of a multimode fiber and be configured to emit visible light from the other end of the multimode fiber. The LED 101 can be configured to emit a light pulse of the order of, for example, picoseconds or nanoseconds or emit continuous light. However, in a case where the LED 101 emits a light pulse, the emission timing of the light pulse is made synchronous with the pulse light emission timing of pulse lasers 201 and 211 of the second emission optical system 20 described below. Moreover, instead of the LED 101, a laser diode (LD) or various lasers can be used. In this case, for the purpose of preventing or reducing a noise component on an acquired image deriving from the highness of coherence, such as speckle noise, an optical element for bringing emission light close to incoherent light as much as possible can be inserted into an optical path used following the emission. The ring slit 103 includes a light transmission portion, through which light passes in the form of a ring-shaped light flux, and a light blocking portion, which blocks light at a portion surrounding the light transmission portion and a central portion of the ring. The ring slit 103 is arranged in a position P103 conjugate to the pupil plane P401 of the objective lens 401. The pinhole 105 is arranged in a position P105 conjugate to the focal plane P501 of the objective lens 401. The ring slit 103 may be reworded as a “ring diaphragm 103”, an “annular slit 103”, or a “circular ring slit 103”. The ring slit 103 is reworded as a “modulation optical element having an annular portion which modulates an intensity component and a phase component of incoherent first primary light”. Moreover, the first emission optical system 10 (phase-difference light source unit) is reworded as a “system including the ring slit 103 as a modulation optical element having an annular portion which modulates an intensity component and a phase component of incoherent first primary light”.

The first emission optical system 10 (phase-difference light source unit) is reworded as an “irradiation optical system configured to emit first primary light including a spatially modulated component”.

### [Phase-Difference Detection Unit]

The first detection unit 70 (phase-difference detection unit) includes relay lenses 702 and 704, a pinhole 703, a phase plate 705, a tube lens 706, and a photodetector 701. The pinhole 703 is arranged in a position P703 conjugate to the focal plane P501 of the light capturing lens 451. The phase plate 705 is composed of an annular portion corresponding to the ring slit 103 and a portion other than the annular portion. In the annular portion, a wave plate, which shifts the phase of light by ¼ relative to the other portion, and an neutral density (ND) filter, which reduces light. The phase plate 705 is arranged in a position P705 conjugate to the pupil plane P451 of the light capturing lens 451. The phase plate 705 is reworded as a “demodulation optical system which annularly demodulates an intensity component of first secondary light received from the specimen 501. Moreover, the first detection unit 70 (phase-difference detection unit) is reworded as a “unit including the phase plate 705 as a demodulation optical system which annularly demodulates an intensity component of first secondary light received from the specimen 501”. The light receiving plane of the photodetector 701 is arranged at the focal plane P701 of the tube lens 706 and is arranged in a position conjugate to the focal plane P501 of the light capturing lens 451. The focal plane P701 may be reworded as a “light receiving plane P701”. The photodetector 701 includes, for example, a photodiode or a photoelectron multiplier. The control unit 90 acquires the intensity of visible light received by the photodetector 701 as a phase-difference signal. It is desirable that the sampling rate of a signal which the photodetector 701 outputs be higher than the pixel rate and the response characteristics of the photodetector 701 be higher in speed than the sampling rate. The annular portion of the phase plate 705 in the first embodiment may be reworded as a “circular ring portion”. The first detection unit 70 (phase-difference detection unit) is reworded as a “unit including the pinhole 703, which blocks part of secondary light, and a pair of relay lenses 702 and 704, which are arranged across the pinhole 703, on an optical path between the relay unit (reverse scanning unit) 60 and the photodetector 701.

### [Second Emission Optical System]

The scanning-type observation apparatus 1 according to the first embodiment includes pulse lasers 201 and 211 as a pair of pulse light sources which is optionally coupled to the second emission optical system 20 and emits two pulse light trains (two types of pulse light) different in oscillation wavelength and synchronous with each other. Such two pulse light trains include a Stokes light train and a pump light train which exert a non-linear optical effect on the specimen 501.

The second emission optical system 20 (SRS light source unit) includes pulse lasers 201 and 211 as a pair of pulse light sources which emits a pair of pulse light trains different in oscillation wavelength and synchronous with each other. The second emission optical system 20 (SRS light source unit) includes relay lenses 202 and 203, a mirror 204, and relay lenses 212 and 213 in association with such a pair of respective pulse light sources. The pair of pulse light trains corresponds to a Stokes light train and a pump light train which exert a non-linear optical effect on a specimen. The Stokes light train and the pump light train may be reworded as a “Stokes light pulse train” and a “pump light pulse train”. The second emission optical system 20 (SRS light source unit) further includes a dichroic mirror 214, which wave-combines the Stokes light train and the pump light train. Additionally, the second emission optical system 20 (SRS light source unit) further includes photoacoustic modulators 205 and 215 which periodically modulate the intensities of pulse light trains respectively emitted from the pulse lasers 201 and 211. In addition, the second emission optical system 20 (SRS light source unit) includes a pulse synchronization detection unit 221 which detects the synchronization of light emission timing of pulse light trains of the pulse lasers 201 and 211. Therefore, the second emission optical system 20 (SRS light source unit) includes beam splitters 222 and 223 which reflect and guide parts of light fluxes emitted from the pulse lasers 201 and 211 to the pulse synchronization detection unit 221. The second emission optical system 20 (SRS light source unit) can be replaced by a configuration which includes at least one of the photoacoustic modulators 205 and 215 in such a way as to periodically modulate at least one of the intensities of pulse light trains emitted from the respective pulse lasers 201 and 211. The photoacoustic modulators 205 and 215 may be reworded as a “modulation unit 205” and a “modulation unit 215”, respectively.

Examples of the pulse lasers 201 and 211 to be used include a mode-locked picosecond titanium-sapphire laser, a mode-locked picosecond neodymium laser, and a mode-locked picosecond ytterbium laser. The time width of each pulse which the pulse lasers 201 and 211 output can be femtoseconds. One of the pulse lasers 201 and 211 can be replaced by an optical parametric oscillator which converts the wavelength of a pulse laser beam which the other of the pulse lasers 201 and 211 has emitted.

Among pulse light trains emitted from the pulse lasers 201 and 211, a light train with the shorter wavelength is used as pump light for SRP induction and a light train with the longer wavelength is used as Stokes light for SRP induction.

The pulse lasers 201 and 211 are adjusted in such a manner that the repetition frequencies of emission of pulse light become the same. The synchronization between the pump light and the Stokes light is detected by the pulse synchronization detection unit 221. For example, the resonator length of one of or both of the pulse lasers 201 and 211 is controlled by the control unit 90 based on a synchronization signal which the pulse synchronization detection unit 221 has detected, and the control unit 90 keeps a state in which the pump light and the Stokes light have been synchronized with each other for a time sufficiently long for the observational time.

The photoacoustic modulators 205 and 215 operate as optical switches which turn on or off transmitted pump light and Stokes light at a predetermined repetitive frequency and a predetermined duty ratio. Thus, the photoacoustic modulators 205 and 215 transmit both pump light and Stokes light in the case of inducing SRP (SRP being turned on) and, on the other hand, blocks any one of or both of pump light and Stokes light in the case of not inducing SRP (SRP being turned off). In the case of blocking only any one of pump light and Stokes light, a photoacoustic modulator can be omitted from an optical path always used for transmission. Furthermore, the photoacoustic modulator can be replaced by another type of optical element which periodically performs transmission and blocking of light, such as an optical chopper.

The dichroic mirror 214 has wavelength characteristics which transmit pulse light emitted from the pulse laser 201 and, on the other hand, reflect pulse light emitted from the pulse laser 211. The dichroic mirror 214 is arranged in such a manner that such reflected light and transmitted light coaxially overlap.

The pulse synchronization detection unit 221 includes a mirror 224, a dichroic mirror 225, a lens 226, and a two-photon detector 227. The dichroic mirror 225 has wavelength characteristics which transmit pulse light emitted from the pulse laser 201 and, on the other hand, reflect pulse light emitted from the pulse laser 211. The dichroic mirror 225 is arranged in such a manner that such reflected light and transmitted light coaxially overlap. The two-photon detector 227 detects two-photon absorption occurring when both pulse light trans for pump light and Stokes light have arrived at the same time.

Furthermore, the second emission optical system 20 (SRS light source unit) can include, to adjust the timing of each pulse light train, a delay optical path (not illustrated) at, for example, the pulse laser 201 or 211, an optical path following that, or the pulse synchronization detection unit 221.

### [Scanning Unit]

The scanning unit 30 includes a two-axis scanner 301 and relay lenses 302 and 303. The two-axis scanner 301 includes two mirrors which swing around two axes perpendicular to each other, and two-dimensionally shifts the angle of incident light with respect to the optical axis and emits the light with the angle thereof shifted. This shifting of angle is controlled by the angles of the two mirrors, so that a scanning point and a scanning range on the specimen plane P501 are controlled. The frequencies of swinging of the two mirrors are made different from each other, so that the specimen plane P501 is two-dimensionally scanned. It is desirable that the midpoint between the two mirrors be in a position conjugate to the pupil plane P401 of the objective lens 401 via the relay lenses 302 and 303. The two-axis scanner 301 to be used can be a two-axis galvanometer scanner. Moreover, the two-axis scanner 301 can be configured by combining a single-axis resonant scanner and a single-axis galvanometer scanner. The relay lenses 302 and 303 are used to cause light to enter the pupil of the objective lens 401 with an appropriate beam diameter and a maximum angle.

The relay unit 60 includes relay lenses 601 and 602 and a two-axis scanner 603. The relay lenses 601 and 602 are used to cause light to enter the two-axis scanner 603 with an appropriate beam diameter and a maximum angle. The two-axis scanner 603 includes two mirrors which swing around two axes perpendicular to each other. The angles of such two mirrors are controlled in such a way as to cancel the shifting of angle relative to the optical axis of the incident light flux. Thus, one mirror of the two-axis scanner 603 and one mirror of the two-axis scanner 301 swing at the same frequency and at the same phase or opposite phases (depending on the manner of arrangement), and the other mirror of the two-axis scanner 603 and the other mirror of the two-axis scanner 301 swing at the same frequency and at the same phase or opposite phases (depending on the manner of arrangement). Accordingly, a light flux which has exited the two-axis scanner 603 travels in parallel to the optical axis or, ideally, on the optical axis. The operation of the two-axis scanner 603 may be referred to as reverse scanning (descanning). It is desirable that the midpoint between the two mirrors of the two-axis scanner 603 be in a position conjugate to the pupil plane P451 of the light capturing lens 451 via the relay lenses 601 and 602.

Particularly, when the light capturing lens 451 and the objective lens 401 are the same, the relay lenses 601 and 602 to be used can be the same as the relay lenses 303 and 302 and the two-axis scanner 603 to be used can be the same as the two-axis scanner 301. In that case, the relay lenses 601 and 602 and the two-axis scanner 603 can be arranged symmetrically with the relay lenses 303 and 302 and the two-axis scanner 301 with respect to the specimen plane P501.

The relay unit 60 in the first embodiment including the two-axis scanner 603 may be reworded as a “reverse scanning unit 60” in view of the function thereof. The reverse scanning unit 60 is configured to perform reverse scanning in synchronization with the scanning unit 30 on an optical path between the wave dividing unit 75 and the second objective lens 45.

### [Wave Combining Unit and Wave Dividing Unit]

The wave combining unit 15 and the wave dividing unit 75 include dichroic mirrors 151 and 751, respectively.

The dichroic mirror 151 has wavelength characteristics which transmit light emitted from the LED 101 and reflect light emitted from the pulse lasers 201 and 211. The dichroic mirror 151 is arranged in such a manner that such reflected light and transmitted light coaxially overlap. The dichroic mirror 751 has wavelength characteristics which transmit light emitted from the specimen 501 after being emitted from the LED 101 and, on the other hand, reflect light emitted from the specimen 501 after being emitted from the pulse lasers 201 and 211. Light reflected by the dichroic mirror 751 is blocked by a beam block 806 placed outside the wave dividing unit 75. The dichroic mirror 751 can be replaced by a short pass filter, a long pass filter, or a band-pass filter each of which has similar wavelength selection characteristics. The wave dividing unit 75 divides secondary light captured by the light capturing lens 451 in such a way as to guide part of the secondary light to the first detection unit 70 and not to guide the other part of the secondary light to the first detection unit 70.

### [Control Unit]

The control unit 90 includes a control device 901, a keyboard 911, a mouse 912, and a display 921. The control device 901 can be formed by installing a program for executing a control processing flow on a computer. Moreover, the control device 901 can include a waveform or signal generator, measuring equipment, a Field Programmable Gate Array (FPGA), a microcomputer, an electrical circuit, and a server each of which executes part of the control processing flow, or can install part of the program on these elements. For example, a waveform generator for controlling the output of the LED 101 can also be included in the control device 901. Moreover, for example, an electrical circuit for controlling one of or both of the pulse lasers 201 and 211 based on a synchronization signal output from the pulse synchronization detection unit 221 can also be included in the control device 901. Moreover, for example, a waveform generator for generating a control signal for the photoacoustic modulators 205 and 215 can also be included in the control device 901. Moreover, for example, an electrical circuit for generating drive signals for the two-axis scanners 301 and 603 can also be included in the control device 901. Moreover, for example, a digitizer for converting an analog signal output from the photodetector 701 into a digital signal or an analyzer for analyzing a signal waveform can also be included in the control device 901. Moreover, for example, an electrical circuit for taking in desired data at a predetermined pixel rate can also be included in the control device 901. Moreover, a server for storing a generated phase-difference image and SRP image or performing image processing or image analysis and network equipment required for communication with the server can also be included in the control device 901.

The control device 901 generates a phase-difference signal and an SRP image based on data acquired by analyzing a signal output from the photodetector 701. At the time of image generation, the control device 901 identifies the position of a light condensing point (measuring point) on the specimen plane P501 based on the control signal for the two-axis scanner 301 and generates data for the respective pixels based on information about the identified position. The control device 901 determines a Raman shift corresponding to the generated SRP image from a difference between the wavelengths of the pulse lasers 201 and 211. The control device 901 generates an SRP image while changing the wavelengths of one of or both of the pulse lasers 201 and 211 as appropriate and generates an SRP spectrum by, for example, plotting the average SRP intensity of the same pixel region relative to the Raman shift. For example, the control device 901 can execute a program for extracting a feature amount of the generated phase-difference image and SRP image or the generated SRP spectrum and finding out a region of interest on the specimen 501 from the feature amount. The control device 901 can execute a preprocessing program or analysis program for an image or spectrum required for the above-mentioned processing. Pieces of information concerning the generated phase-difference image, SRP image, and SRP spectrum, the feature amount, and the region of interest are then stored in a storage device (not illustrated) of the control device 901 or can be output toward the display 921. The storage device is, for example, a solid state drive or a hard disk drive. The storage device can be included in the server.

The keyboard 911 and the mouse 912 are connected to the control device 901, and the operator can input an instruction to the control device 901 by operating the keyboard 911 and the mouse 912. The control device 901 is connected to the LED 101, the pulse lasers 201 and 211, the two-axis scanners 301 and 603, the stage scanner 512, and the photodetector 701, and controls operations of these elements according to instructions received from the operator.

The display 921 visually returns a feedback with respect to an operation performed by the operator and, at the same time, displays an image and a character string which the control device 901 has output.

### [Phase-Difference Observation System]

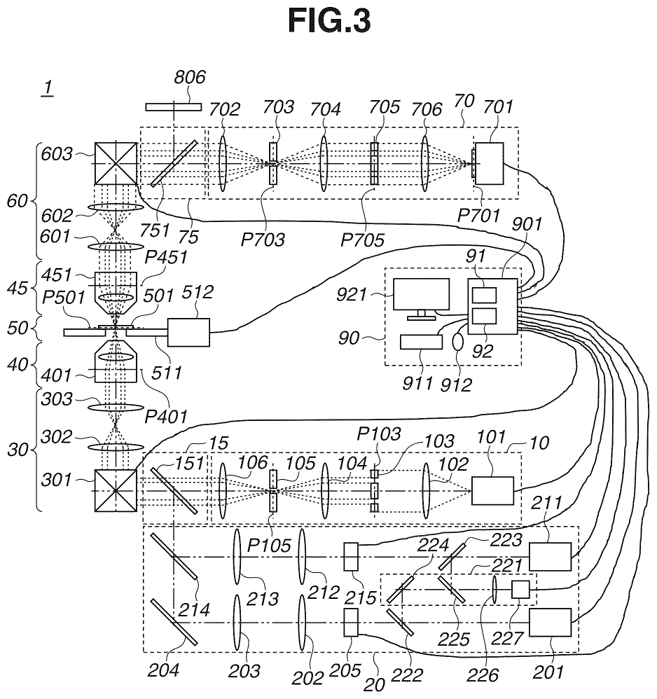

FIG. 3 is a schematic diagram illustrating a phase-difference observation system of the scanning-type observation apparatus 1 according to the first embodiment. Phase-difference observation in the scanning-type observation apparatus 1 uses the first emission optical system 10 (phase-difference light source unit), the wave combining unit 15, the scanning unit 30, the first objective lens 40, the placement unit 50, the second objective lens 45, the relay unit 60, the wave dividing unit 75, the first detection unit 70 (phase-difference detection unit), and the control unit 90.

As shown by dotted lines in FIG. 3, light emitted from the LED 101 of the first emission optical system 10 (phase-difference light source unit) becomes a parallel light flux by the collimator 102. An annular light flux having passed through the ring slit 103 is condensed to one point toward the pinhole 105 by the relay lens 104. At this time, first-order or higher diffracted light occurring at the edge of the ring slit 103 broadens the light condensing point. The pinhole 105 blocks light in a portion surrounding the light condensing point and transmits light near the center portion, thus increasing the proportion of light going straight through the ring slit 103 (in other words, zero-th order diffracted light). This prevents or reduces a light flux which has become annular again by the relay lens 106 from being destroyed in shape during the process of propagating through a subsequent optical path. Therefore, it is possible to prevent or reduce an artifact on a phase-difference signal to be acquired.

The parallel light flux the diameter of the circular ring of which has been enlarged or reduced by the relay lens 106 passes through the dichroic mirror 151 of the wave combining unit 15 and then enters the two-axis scanner 301 of the scanning unit 30.

The ring-shaped light flux is reflected by each of the two mirrors of the two-axis scanner 301. The ring-shaped light flux which has exited the two-axis scanner 301 in parallel to the optical axis or while being inclined with respect to the optical axis is enlarged or reduced in the diameter of the circular ring thereof by the relay lenses 302 and 303, and then enters the objective lens 401 of the first objective lens 40. The light flux is then condensed by the objective lens 401 to one point toward the specimen 501 in the placement unit 50. The position of the light condensing point in the specimen plane P501 corresponds to the angle of the light flux which has exited the two-axis scanner 301 with respect to the optical axis. At this time, in addition to straight light going through the specimen 501 (in other words, zero-th diffracted light), first-order or higher diffracted light associated with a spatial distribution of the refractive index of the specimen 501 occurs. Accordingly, in response to the refractive index of the specimen 501 being changed by a stimulated Raman photothermal effect (SRP), the diffracted light also changes.

The straight light and the diffracted light which have exited the specimen 501 are captured by the objective lens 451 (light capturing lens 451), are made into parallel light fluxes thereby, and then exit the objective lens 451. At this time, the straight light in the specimen 501 becomes annular and the inner side and outer side of the circular ring thereof become diffracted light occurring in the specimen 501. The emergence angle of the parallel light flux corresponds to the position of the light condensing point in the specimen plane P501, i.e., the angle of a light flux which has exited the two-axis scanner 301 with respect to the optical axis. The light flux which has exited the objective lens 451 is enlarged or reduced in the beam diameter thereof by the relay lenses 601 and 602 of the relay unit 60 and then enters the two-axis scanner 603. The entering light flux is reflected by each of the two mirrors of the two-axis scanner 603. The light flux which has exited the two-axis scanner 603 in parallel to or in conformity with the optical axis irrespective of the incident angle passes through the dichroic mirror 751 of the wave dividing unit 75 and then enters the relay lens 702 of the first detection unit 70 (phase-difference detection unit).

The entering light flux is condensed to one point toward the pinhole 703 by the relay lens 702. The pinhole 703 blocks light in a portion surrounding the light condensing point and thus blocks diffracted light or scattering light occurring in a portion other than the light condensing point in the specimen plane P501. This enables preventing or reducing an artifact on a phase-difference signal to be acquired.

The light flux which has passed through the pinhole 703 is enlarged or reduced in the beam diameter thereof by the relay lens 704, becomes a parallel light flux again, and then passes through the phase plate 705. At this time, straight light in the specimen 501 passes through the circular ring portion of the phase plate 705 and is thus subjected to phase modulation and light reduction and, on the other hand, diffracted light in the specimen 501 passes through a portion other than the circular ring portion of the phase plate 705. The light flux which has exited the phase plate 705 is condensed to one point toward the light receiving plane P701 of the photodetector 701 by the tube lens 706. In the light receiving plane P701, straight light and diffracted light in the specimen 501 interfere with each other, and the photodetector 701 detects the light intensity of such interference. Accordingly, a change in the diffracted light caused by the refractive index change of the specimen 501 caused by SRP appears as a change in light intensity which the photodetector 701 detects. Light which has arrived at the detection surface of the photodetector 701 may be referred to as “phase-difference detection light”.

### [SRP Induction System]

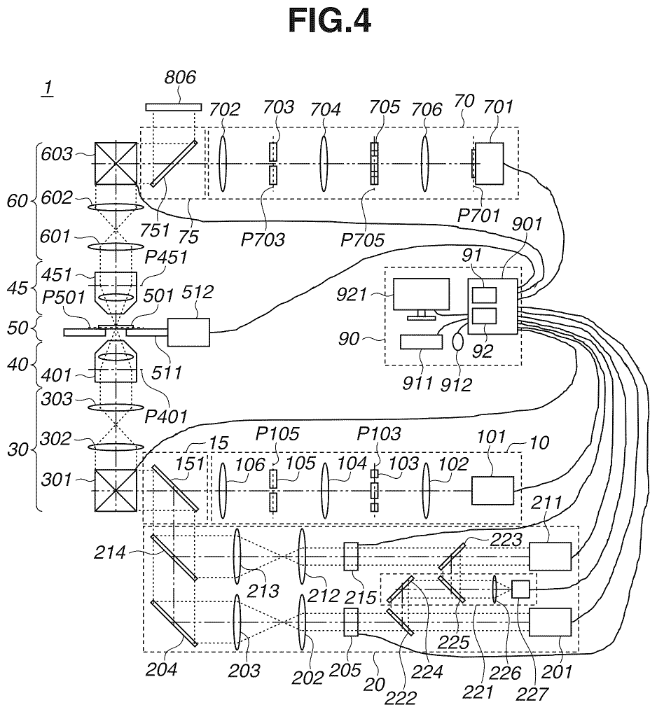

FIG. 4 is a schematic diagram illustrating a stimulated Raman photothermal (SRP) induction system of the scanning-type observation apparatus 1 according to the first embodiment. SRP induction in the scanning-type observation apparatus 1 uses the second emission optical system 20 (SRS light source unit), the wave combining unit 15, the scanning unit 30, the first objective lens 40, the placement unit 50, the second objective lens 45, the relay unit 60, the wave dividing unit 75, and the control unit 90.

As shown in dotted lines in FIG. 4, with regard to a light flux which the pulse laser 201 of the SRS light source unit 20 has emitted, a part of the light flux is reflected by the beam splitter 222 and then enters the pulse synchronization detection unit 221 and, on the other hand, the other major portion of the light flux passes through the beam splitter 222 and then enters the photoacoustic modulator 205. A light flux which has exited the photoacoustic modulator 205 then enters the relay lens 202. The light flux which has been enlarged or reduced in the beam diameter thereof by the relay lenses 202 and 203 is reflected by the mirror 204 and then passes through the dichroic mirror 214.

With regard to a light flux which the pulse laser 211 has emitted, a part of the light flux is reflected by the beam splitter 223 and then enters the pulse synchronization detection unit 221 and, on the other hand, the other major portion of the light flux passes through the beam splitter 223 and then enters the photoacoustic modulator 215. A light flux which has exited the photoacoustic modulator 215 then enters the relay lens 212. The light flux which has been enlarged or reduced in the beam diameter thereof by the relay lenses 212 and 213 is reflected by the dichroic mirror 214. At this time, the reflected light flux is made to coaxially overlap with the above-mentioned light flux which has passed through the dichroic mirror 214.

The light flux from the pulse laser 201 reflected by the beam splitter 222 is reflected by the mirror 224 of the pulse synchronization detection unit 221 and then passes through the dichroic mirror 225. The light flux from the pulse laser 211 reflected by the beam splitter 223 is reflected by the dichroic mirror 225. At this time, the reflected light flux is made to coaxially overlap with the light flux which has passed through the dichroic mirror 225. The light fluxes made to coaxially overlap (in other words, both light fluxes for pump light and Stokes light) are condensed toward the two-photon detector 227 by the lens 226.

The light fluxes made to coaxially overlap (in other words, both light fluxes for pump light and Stokes light) by the dichroic mirror 214 are reflected the dichroic mirror 151 of the wave combining unit 15. At this time, the reflected light fluxes are made to coaxially overlap with the annular light flux which has been emitted from the first emission optical system 10 (phase-difference light source unit) and has passed through the dichroic mirror 151.

A light flux reflected by the dichroic mirror 151 enters the two-axis scanner 301 of the scanning unit 30 and is then reflected by each of the two mirrors of the two-axis scanner 301. The light flux which has exited the two-axis scanner 301 is enlarged or reduced in the beam diameter thereof by the relay lenses 302 and 303 and then enters the objective lens 401 of the first objective lens 40. The light flux is condensed to one point toward the specimen 501 on the placement unit 50 by the objective lens 401. The position of the light condensing point in the specimen plane P501 corresponds to the angle at which the light flux exits the two-axis scanner 301 with respect to the optical axis. At this time, a stimulated Rahman process occurs at the light condensing point, so that SRP is induced. Thus, correspondingly with a vibrational level of molecules existing in the light condensing point, stimulated Raman loss occurs for pump light and stimulated Raman gain occurs for Stokes light, so that a refractive-index change occurs due to heat caused by an accompanying molecular vibrational relaxation. Furthermore, since, in addition to pump light and Strokes light, light which has been emitted from the first emission optical system 10 (phase-difference light source unit) is also coaxially condensed, light condensing points for such three light fluxes have a spatial overlap. Therefore, a refractive-index change caused by SRP is detected as a change in diffracted light in a phase difference.

Pump light and Stokes light which have exited the specimen 501 are captured by the light capturing lens 451, become a parallel light flux, and then exits the light capturing lens 451. At this time, the angle of emergence relative to the optical axis corresponds to the position of the light condensing point in the specimen plane P501, in other words, the angle of the light flux which has exited the two-axis scanner 301 with respect to the optical axis. The light flux which has exited the light capturing lens 451 is enlarged or reduced in the beam diameter thereof by the relay lenses 601 and 602 of the relay unit 60 and then enters the two-axis scanner 603.

The entering light flux is reflected by each of the two mirrors of the two-axis scanner 603. The light fluxes for pump light and Stokes light which have exited the two-axis scanner 603 in parallel to or in conformity with the optical axis irrespective of the incident angle are reflected by the dichroic mirror 751 of the wave dividing unit 75 and are then blocked by the beam block 806.

### [Light Irradiation Timing]

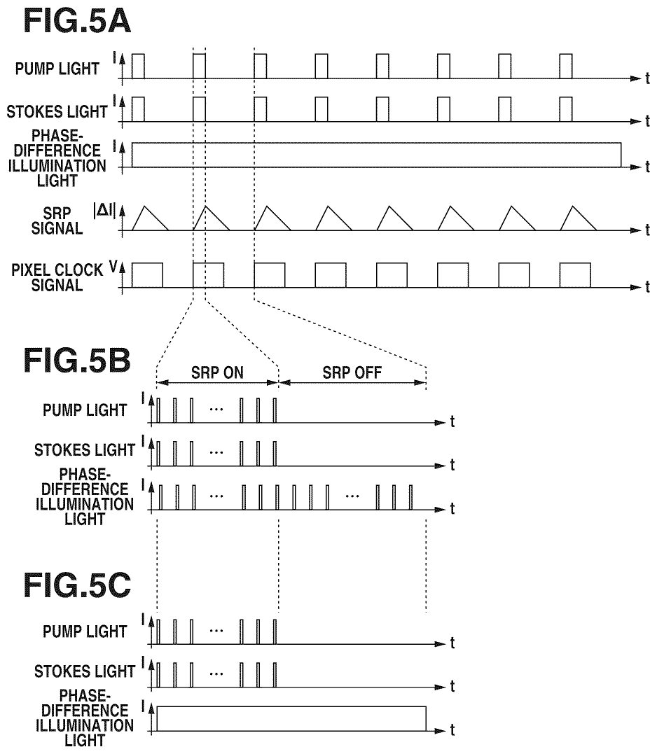

FIGS. 5A, 5B, and 5C are schematic diagrams illustrating an example of light irradiation timing for light which is radiated onto the specimen 501 in the scanning-type observation apparatus 1 according to the first embodiment. FIG. 5A illustrates an example of temporal transitions of pump light, Stokes light, and phase-difference illumination light in given consecutive measuring points in a case where the energy difference between pump light and Stokes light approximately coincides with the energy difference of a vibrational level of molecules. Here, one measuring point can be reworded as “one cycle of measurement”. Moreover, consecutive measuring points can be regarded as the repetition of measurement cycles and, thus, can be reworded as a “plurality of cycles of measurement”. In addition, FIG. 5A illustrates an example of the magnitude of an SRP signal, in other words, a temporal transition of the magnitude |ΔI| of a change in the phase-difference detection light intensity correlated to a refractive-index change Δn caused by SRP. Additionally, FIG. 5A also illustrates an example of a pixel clock signal (voltage V). Here, the rising of the pixel clock signal is set to timing of the start of measurement for each pixel, and one pixel corresponds to one measuring point. Furthermore, a configuration which makes one pixel associated with a plurality of, two or more, measuring points and generates data for one pixel with use of signals and pieces of data acquired at the plurality of measuring points can be employed. FIGS. 5B and 5C illustrate, under magnification, examples of temporal transitions of intensities of pump light, Stokes light, and phase-difference illumination light at one optional measuring point illustrated in FIG. 5A. FIG. 5B illustrates a case where the phase-difference illumination light is pulse light, and FIG. 5C illustrates a case where the phase-difference illumination light is continuous light.

Within one cycle of measurement, a time frame of SRP on, in which both pump light and Stokes light are radiated onto the specimen 501, and a time frame of SRP off, in which neither both pump light nor Stokes light is radiated onto the specimen 501, exist (FIG. 5A). On the other hand, phase-difference illumination light is continuously radiated onto the specimen 501 irrespective of the time frames of SRP on and SRP off. In the time frame of SRP on, pump light and Stokes light are radiated onto the specimen 501 in a temporally overlapping manner (FIGS. 5B and 5C). Both pump light and Stokes light are repeatedly radiated onto the specimen 501 as long as the time of SRP on continues. On the other hand, phase-difference illumination light, in the case of being pulse light, is radiated onto the specimen 501 while temporally overlapping with pump light and Stokes light or while being a little late (FIG. 5B). This enables efficiently detecting SRP before heat caused by a stimulated Raman process occurring by one light irradiation of pump light and Stokes light is dissipated. Phase-difference illumination light, in the case of being continuous light, continues to be radiated onto the specimen 501 at a constant intensity irrespective of pulse irradiation timing of pump light and Stokes light (FIG. 5C).

In the time frame of SRP on, due to a repeatedly occurring stimulated Raman process, heat accumulates before dissipating at the measuring point, so that the amount of change of the refractive index also increases. Accordingly, an SRP signal (the intensity change of phase-difference detection light) also increases (FIG. 5A). It is necessary to note that, in a case where the SRP on time is too long, the generation and dissipation of heat balance at the measuring point so that the SRP signal becomes saturated.

In the time frame of SRP off, the heat having locally accumulated at the measuring point dissipates. Along with the dissipation of heat, the refractive index asymptotically approaches a refractive index obtained before SRP on (the original refractive index). Accordingly, phase-difference detection light also asymptotically approaches the intensity obtained before SRP on (the original intensity) (FIG. 5A). It is desirable to wait until the temporal change of phase-difference detection light intensity becomes sufficiently small (to sufficiently ensure the SRP off time), and, particularly, it is necessary to note a case where one pixel is associated with a plurality of measuring points (a plurality of cycles of measurement). Accordingly, it is desirable to set the proportion of the SRP on time in one cycle time (duty ratio) to less than 50%.

### [Generation of Raman Image and Phase-Difference Image]

The intensity of phase-difference detection light which is acquired at timing at which the SRP signal becomes largest in one cycle of measurement illustrated in FIG. 5A, i.e., immediately after starting of the latter half of the time frame of SRP on, is referred to as an “SRP on intensity”. Then, a spatial distribution of the SRP on intensity in the specimen plane P501 is referred to as an “SRP on image”. On the other hand, the intensity of phase-difference detection light which is acquired at timing at which the SRP signal becomes sufficiently small in one cycle of measurement i.e., at the latter half of the time frame of SRP off, is referred to as an “SRP off intensity”.

Then, a spatial distribution of the SRP off intensity in the specimen plane P501 is referred to as an “SRP off image”. In a case where the timing of measurement start of each pixel (here, the rising of the pixel clock signal) is earlier than the timing of SRP on start, the intensity of phase-difference detection light obtained before the SRP on starts can be set as the SRP off intensity.

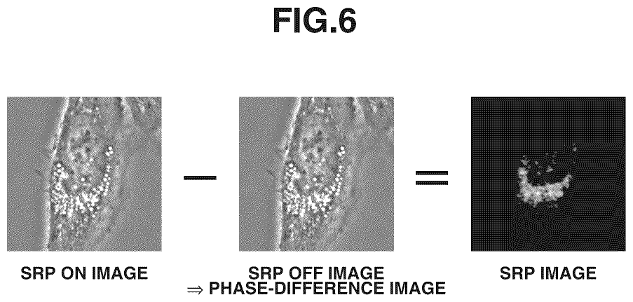

FIG. 6 is a diagram used to explain a method of generating an SRP image and a phase-difference image. The SRP image, in other words, a Raman image, is obtained by subtracting the SRP off image from the SRP on image. On the other hand, the phase-difference image can be obtained by repurposing the SRP off image. This is because, in the SRP off image, the influence of SRP is negligibly small. Since the SRP image and the phase-difference image are generated based on signals acquired at the same measuring point and at the same time of point, the respective pixels of the SRP image and the phase-difference image correspond to each other in a one-to-one relationship. Furthermore, in a generation processing flow of an SRP image, the SRP image can be calculated after the SRP on image and the SRP off image are generated, or the SRP image can be generated after the SRP intensity is calculated for each pixel from the SRP on image and the SRP off image.

### [Observation Processing Flow]

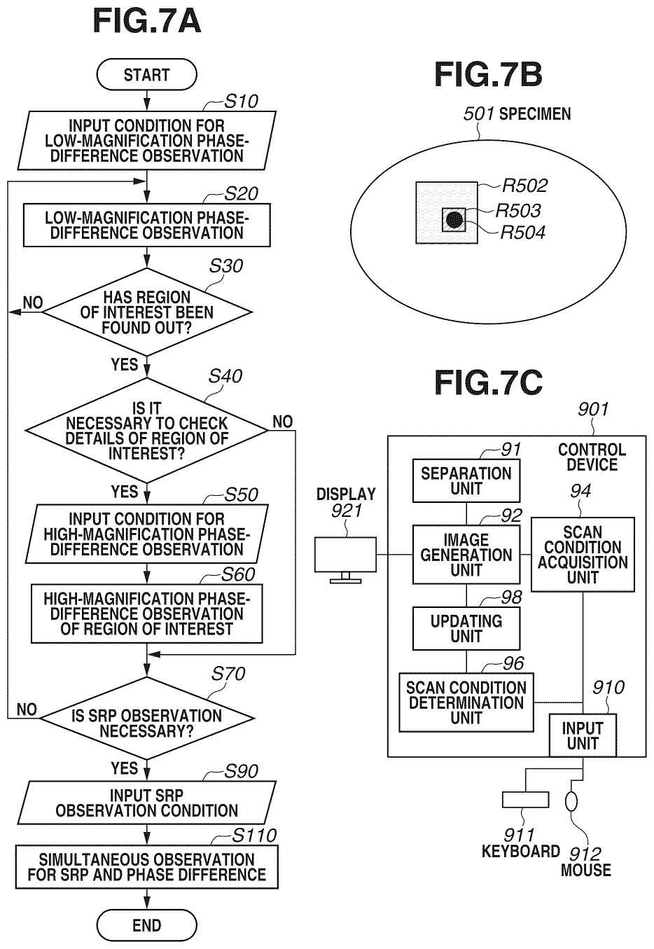

FIGS. 7A, 7B, and 7C are diagrams illustrating examples of an observation processing flow for the specimen 501 using the scanning-type observation apparatus 1 according to the first embodiment. FIG. 7A is a flowchart illustrating an example of the observation processing flow, and FIG. 7B is a diagram used to explain a low-magnification field of view R502, a high-magnification field of view R503, and a region of interest R504. Moreover, FIG. 7C is a diagram illustrating an outline configuration of a scan condition determination unit.

As illustrated in FIG. 7C, the control unit 90 includes an image generation unit 92, which generates a first image captured at the first objective lens 40 and the second objective lens 45 with a predetermined magnification and displays the first image on the display unit 921 (display). The control unit 90 further includes an input unit 910, which receives and accepts inputting of information about a region of interest from the operator based on the displayed first image, and a scan condition acquisition unit 94, which acquires a scan condition SC0 for the scanning unit 30 based on the received information about a region of interest. The control unit 90 further includes a scan condition determination unit 96, which determines a scan condition SC1 at the time of image capturing for the scanning unit 30 based on the acquired scan condition SC0. The control unit 90 further includes an updating unit 98, which displays the scan condition SC1 acquired by the scan condition determination unit 96 on the display unit 921 and receives and accepts updating of the scan condition SC1.

### [Separation Unit]

The control unit 90 includes a separation unit 91, which temporally demodulates a signal received from the first detection unit 70 and separates the signal into a first signal S1, which corresponds to a non-linear photothermal effect PTE occurring at the specimen 501 due to irradiation of second light, and a second signal S2, which includes no non-linear photothermal effect. The separation unit 91 includes a configuration which, by attenuating a first signal S1 corresponding to the non-linear photothermal effect PTE, temporally demodulates a signal received from the first detection unit 70 and separates, from the signal, a second signal S2 which substantially includes no non-linear photothermal effect. The separation unit 91 includes a configuration which, by attenuating a second signal S2 which substantially includes no non-linear photothermal effect, temporally demodulates a signal received from the first detection unit 70 and separates and acquires, from the signal, a first signal S1 corresponding to the non-linear photothermal effect PTE.

### [Image Generation Unit]

The control unit 90 includes the image generation unit 92, which performs imaging based on scan information 30i concerning the scanning unit 30 and at least one of the first signal S1 and the second signal S2 obtained by separation by the separation unit 91. Thus, the image generation unit 92 generates at least one of a stimulated Raman photothermal effect image (SRP image), which is obtained by imaging the first signal S1, and a phase-difference image, which is obtained by imaging the second signal S2. The scan information 30i includes, for example, the position (X-coordinate, Y-coordinate) of a focus of the first light (second light) and time t.

Initially, the operator causes the specimen 501 to be held by the stage 511. From this state, the observation processing flow starts. First, the operator performs phase-difference observation of the specimen 501 with a wide field of view. In step S10 and step S20, the operator inputs a condition for low-magnification phase-difference observation to the control device 901 and then starts the low-magnification phase-difference observation.

By driving the stage scanner 512 to change the position of the stage 511, the operator moves the low-magnification field of view R502 illustrated in FIG. 7B. If the region of interest R504 of the specimen 501 is not present within the low-magnification field of view R502 (NO in step S30), then in step S20, the operator moves the low-magnification field of view R502 and continues the low-magnification phase-difference observation, and, on the other hand, if the region of interest R504 has been found out (YES in step S30), the operator completes the low-magnification phase-difference observation. In this way, initially performing real-time phase-difference observation of the specimen 501 with a wide field of view enables shortening an amount of time required for the acquisition of the position of the specimen 501 relative to the specimen plane P501 and the find of the region of interest R504. This enables preventing or reducing any damage to the specimen 501.

Next, in step S40, the operator determines whether to check the details of a phase-difference image of the region of interest R504 based on a low-magnification phase-difference image. In the case of checking the details (YES in step S40), the operator performs real-time phase-difference observation with a field of view narrowed. In that case, in step S50 and step S60, the operator inputs a high-magnification phase-difference observation condition to the control device 901 and then starts high-magnification phase-difference observation. As need arises, the operator moves the high-magnification field of view R503 illustrated in FIG. 7B in such a manner that the region of interest R504 falls within the high-magnification field of view R503 and considers the necessity of SRP observation based on a high-magnification phase-difference image. On the other hand, in the case of not checking the details of a phase-difference image of the region of interest R504 (NO in step S40), then in step S70, the operator considers the necessity of SRP observation based on a low-magnification phase-difference image. If it is determined, based on the low-magnification phase-difference image, that SRP observation is not necessary (NO in step S70), the operator returns the observation processing to the low-magnification phase-difference observation (step S20) and looks for another region of interest R504 of the specimen 501. On the other hand, if it is determined that SRP observation is necessary (YES in step S70), the operator performs the SRP observation. In this way, performing, under magnification, phase-difference observation of the region of interest R504 of the specimen 501 enables promptly determining the necessity of SRP observation. Therefore, it is possible to reduce unnecessary SRP observation, and, while improving the efficiency of measurement, it is also possible to prevent or reduce any damage to the specimen 501. Until the above-described phase-difference observation is complete, both pump light and Stokes light can be set turned off. Thus, a phase-difference image can be acquired in a state in which only phase-difference illumination light is in the on-state.

Next, in step S90, the operator inputs an SRP observation condition (in other words, an SRP image acquisition condition) to the control device 901 and starts SRP observation. At this stage, the operator can turn on pump light and Stokes light for the first time. If the simultaneous observation for SRP observation and phase-difference observation (in other words, observation of an SRP image and an SRP off image) is complete in step S110, the operator ends the observation processing in the flowchart of FIG. 7A.

Furthermore, the low-magnification and high-magnification phase-difference observation conditions include, for example, the intensity and pulse time width of a light output of the LED 101, the number of times of cumulation, and the magnitude of a field of view. The SRP observation condition includes, for example, the intensities and center wavelengths, the pulse wavelength widths, and the pulse time widths of light outputs of the pulse lasers 201 and 211, the number of times of cumulation, the duty ratio of the repetition frequency of transmission or blocking of the photoacoustic modulators 205 and 215, and the magnitude of a field of view.

In the observation processing flow illustrated in FIG. 7A, in a case where, in step S30, the region of interest R504 has been found out, then in step S50 and in step S90, the operator inputs the respective observation conditions. To improve the convenience to the operator, step S35 (not illustrated) in which the operator inputs position information about the region of interest R504 can be added to between step S30 and step S40. For example, the position information can be input by the operator, with respect to a low-magnification phase-difference image displayed on the display 921 of the control unit 90, trailing the outline of the region of interest R504 or drawing a mark with use of the mouse 912. Then, based on the above-mentioned position information, the control device 901 can predict the respective appropriate observation conditions and automatically input them in step S50 and step S90 or present them to the operator. In this way, supporting the operator to input the respective observation conditions enables reducing a burden on the operator.

In the case of adding the above-mentioned step S35, the control device 901 can determine appropriate observation conditions based on the above-mentioned position information and can automatically performing inputting of the respective observation conditions in step S50 and step S90. This enables saving the operator's trouble of inputting the respective observation conditions and further reducing a burden on the operator.

In the observation processing flow illustrated in FIG. 7A, the control unit 90 can automatically perform finding-out of the region of interest R504 and identifying of the position information about the region of interest R504. That enables reducing a burden on the operator performing observation.

Furthermore, while, in the scanning-type observation apparatus 1 illustrated in FIG. 2, the ring slit 103 is arranged in the first emission optical system 10 (phase-difference light source unit) and the phase plate 705 is arranged in the first detection unit 70 (phase-difference detection unit), even if both are swapped to be arranged, it is possible to acquire a phase-difference signal.

As described above, since the scanning-type observation apparatus 1 according to the first embodiment of the present disclosure generates an SRP image (in other words, a Raman image) and a phase-difference image based on phase-difference signals for SRP on and SRP off which are acquired at the spatially and temporally same measuring point, pixels of both images correspond to each other in a one-to-one relationship. Thus, it is possible to acquire primary images of a phase-difference image and an SRP image (a Raman image) the image qualities of which are consistent with each other. This enables reducing a burden on the operator concerning the consistency of image quality.

### Second Embodiment

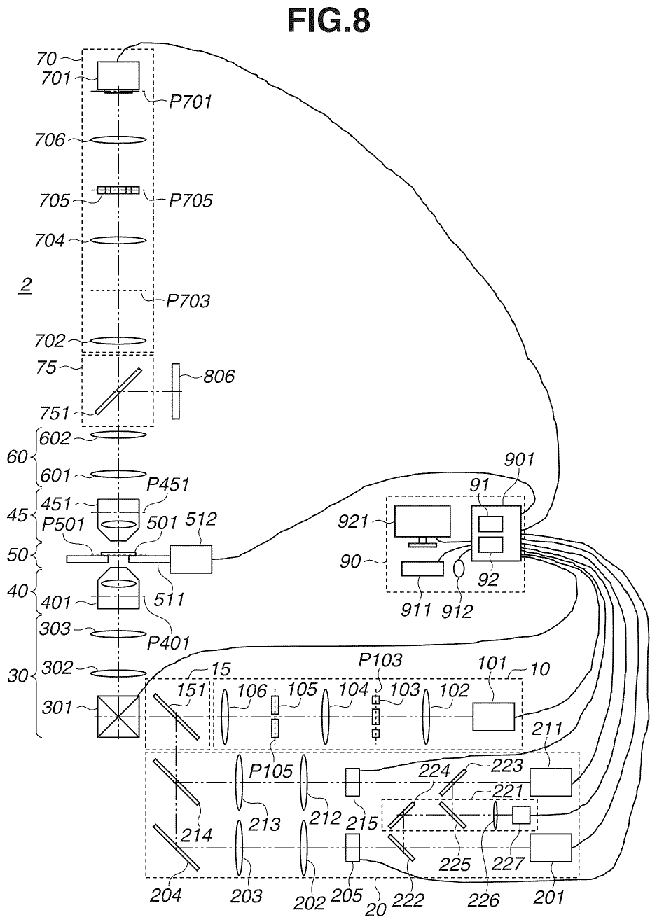

A configuration of a scanning-type observation apparatus according to a second embodiment of the present disclosure is described with reference to FIG. 8. FIG. 8 is a schematic diagram illustrating a configuration of the scanning-type observation apparatus 2 according to the second embodiment. The scanning-type observation apparatus 2 has the same configuration as that of the scanning-type observation apparatus 1 in the first embodiment except for portions described below. Therefore, constituent elements which are in common with those in the first embodiment are assigned the respective same reference numerals as those in the first embodiment and any duplicate description thereof is omitted here.

In the scanning-type observation apparatus 2 illustrated in FIG. 8, the two-axis scanner 603 of the relay unit 60 of the scanning-type observation apparatus 1 is removed, and, at that position, a dichroic mirror 751 of the wave dividing unit 75 is arranged. In addition, the pinhole 703 of the first detection unit 70 (phase-difference detection unit) of the scanning-type observation apparatus 1 is removed. The relay unit 60 in the second embodiment differs from that in the first embodiment in that the relay unit 60 is not electrically connected to the control unit 90.

The scanning-type observation apparatus 2 does not include a two-axis scanner which cancels out shifting of the angle of a light flux entering the relay unit 60 relative to the optical axis. Accordingly, in the scanning-type observation apparatus 2, the angle of a light flux exiting the relay unit 60 relative to the optical axis corresponds to the position of the light condensing point in the specimen plane P501, in other words, the angle of a light flux exiting the two-axis scanner 301 of the scanning unit 30 relative to the optical axis.

### [Wave Dividing Unit]

The dichroic mirror 751 of the wave dividing unit 75 in the scanning-type observation apparatus 2 has wavelength characteristics similar to those in the scanning-type observation apparatus 1. The dichroic mirror 751 in the scanning-type observation apparatus 2 is placed in the vicinity of a position conjugate to the pupil plane P451 of the light capturing lens 451 of the second objective lens 45 via the relay lenses 601 and 602 of the relay unit 60.

### [Phase-Difference Detection Unit]

The first detection unit 70 (phase-difference detection unit) in the scanning-type observation apparatus 2 does not include the pinhole 703 in the position (in other words, an intermediate image forming plane) P703 conjugate to the focal plane P501 of the light capturing lens 451. In the intermediate image forming plane P703, a point-like image moves in association with the light condensing point which moves in a scanning manner on the specimen plane P501. Similarly, even on the focal plane P701 of the tube lens 706 which is located at a position conjugate to the focal plane P501, a point-like image moves. Accordingly, the photodetector 701 in the scanning-type observation apparatus 2 needs to have a light receiving area larger than that in the scanning-type observation apparatus 1. Therefore, the photodetector 701 to be used in the scanning-type observation apparatus 2 can be, in addition to a photoelectron multiplier or photodiode having a large light receiving area, a photodiode array in which a plurality of photodiodes is two-dimensionally arranged.

The phase plate 705 of the first detection unit 70 (phase-difference detection unit) in the scanning-type observation apparatus 2 is similar to that in the scanning-type observation apparatus 1 in that the phase plate 705 is arranged at a position conjugate to the pupil plane P451 of the light capturing lens 451.

However, the phase plate 705 of the first detection unit 70 (phase-difference detection unit) in the scanning-type observation apparatus 2 is different from that in the scanning-type observation apparatus 1 in that the angle of a light flux passing through the phase plate 705 relative to the optical axis changes in association with the position of a light condensing point in the specimen plane P501, in other words, the angle of a light flux exiting the two-axis scanner 301 relative to the optical axis. In view of that, it is necessary to design a circular ring portion of the phase plate 705 which modulates the phase of straight light (zero-th diffracted light) in the specimen 501 and reduces the straight light.

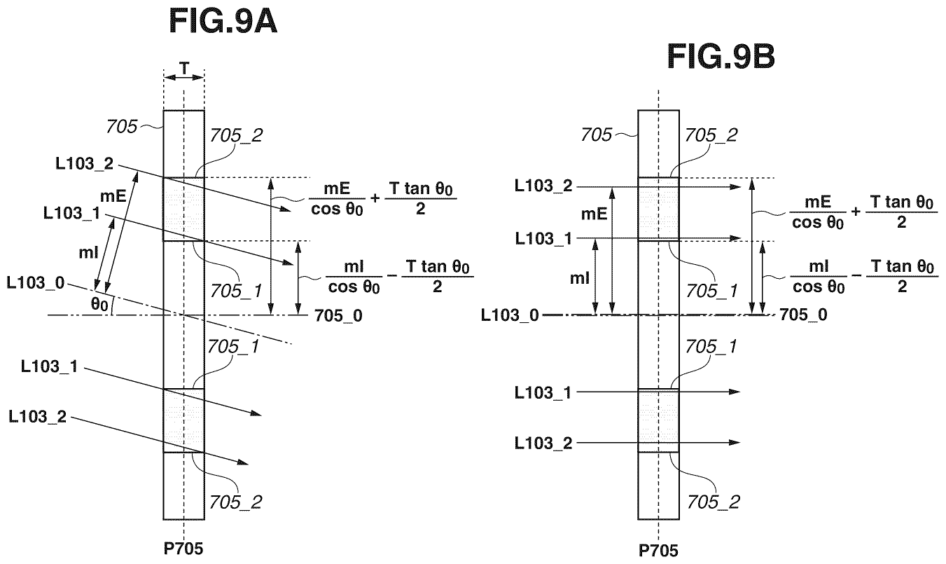

FIGS. 9A and 9B are schematic diagrams used to explain a relationship between the phase plate 705 in the scanning-type observation apparatus 2 and a set of light fluxes passing through the phase plate 705, according to the second embodiment. The phase plate 705 includes two concentric cylinders 705_1 and 705_2 around a central axis 705_0 coincident with the optical axis. In an area sandwiched between the inner cylinder 705_1 and the outer cylinder 705_2 (shaded portions in FIGS. 9A and 9B), a ¼ wave plate and a neutral density (ND) filter are formed. An annular parallel light flux formed by straight light in the specimen 501 passes through the sandwiched area. In the annular parallel light flux, the innermost light flux L103_1 and the outermost light flux L103_2 draw concentric cylinders around a principal ray of a parallel light flux (including both straight light and diffracted light in the specimen 501) passing through the phase plate 705. The diameters of cylinders of the light flux L103_1 and the light flux L103_2 respectively correspond to the inner diameter and outer diameter of the ring slit 103 present at a position conjugate to a plane P705 in which the center of the thickness of the phase plate 705 is arranged. Specifically, by multiplying each of the inner radius I and the outer radius E of the ring slit 103 by an image forming magnification m, the radius of the light flux L103_1 becomes ml and the radius of the light flux L103_2 becomes mE.

FIG. 9A illustrates the manner obtained when the angle of a parallel light flux passing through the phase plate 705 relative to the optical axis becomes maximum. In FIG. 9A, a principal ray L103_0 forms a maximum angle θ0 to the optical axis 705_0 and intersects with the optical axis 705_0 on the plane P705 coincident with the center of the thickness of the phase plate 705. At this time, since all of the light fluxes between the light fluxes L103_1 and L103_2 pass through an area sandwiched between the cylinders 705_1 and 705_2 of the phase plate 705, the radii of the cylinders 705_1 and 705_2 satisfy the following formulae (1) and (2):

$$( Radius of cylinder 705 \_ 1 ) \leq \frac{ml}{cos {θ}_{0}} - \frac{T tan {θ}_{0}}{2} , and \qquad ( 1 )$$

$$( Radius of cylinder 705 \_ 2 ) \geq \frac{mE}{cos {θ}_{0}} + \frac{T tan {θ}_{0}}{2} . \qquad ( 2 )$$

Furthermore, in formulae (1) and (2), the incident angle of a light flux to the phase plate 705 is supposed to be 10° at most, and refractions occurring at the ¼ wave plate or ND filter are not taken into consideration. More accurately, it is desirable to determine the above-mentioned radii in consideration of these refractions.

FIG. 9B illustrates the manner obtained when a parallel light flux passing through the phase plate 705 becomes parallel to the optical axis. When the radii of the cylinders 705_1 and 705_2 satisfy the above-mentioned formulae (1) and (2), all of the light fluxes between the light fluxes L103_1 and L103_2 pass through an area sandwiched between the cylinders 705_1 and 705_2 of the phase plate 705.

In this way, performing design in such a manner that, irrespective of the angle of a light flux passing through the phase plate 705 to the optical axis, all of the straight light fluxes in the specimen 501 are subjected to phase modulation and light reduction in the phase plate 705 enables preventing or reducing an artifact occurring in a phase-difference image to be acquired.

As described above, since the scanning-type observation apparatus according to the second embodiment of the present disclosure does not include a two-axis scanner in the relay unit 60, it is possible to simplify control and, additionally, to facilitate optical path adjustment. This enables improving the stability of the scanning-type observation apparatus.

### Third Embodiment

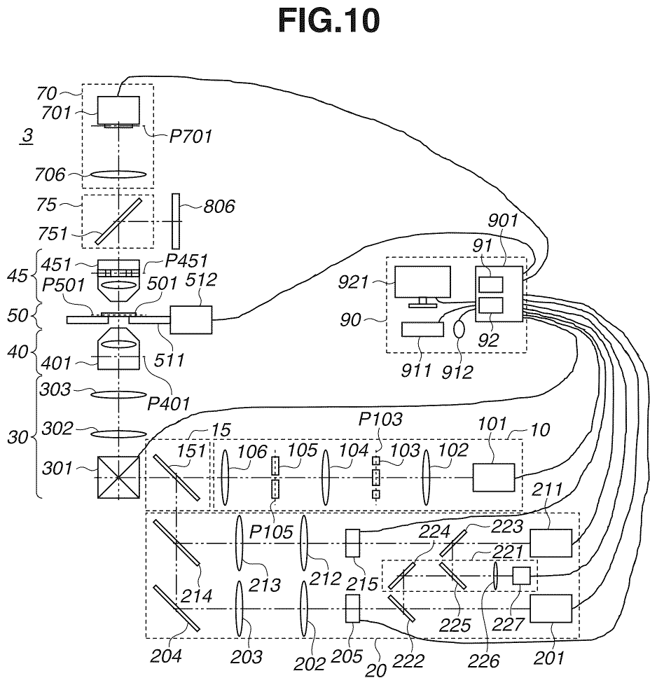

A configuration of a scanning-type observation apparatus according to a third embodiment of the present disclosure is described with reference to FIG. 10. FIG. 10 is a schematic diagram illustrating a configuration of the scanning-type observation apparatus 3 according to the third embodiment. The scanning-type observation apparatus 3 has the same configuration as that of the scanning-type observation apparatus 2 in the second embodiment except for portions described below. Therefore, constituent elements which are in common with those in the second embodiment are assigned the respective same reference numerals as those in the second embodiment and any duplicate description thereof is omitted here.

In the scanning-type observation apparatus 3 illustrated in FIG. 10, the phase plate 705, which has been arranged in the first detection unit 70 (phase-difference detection unit) in the case of the scanning-type observation apparatus 2, is displaced to the inside of the second objective lens 45 (light capturing lens). Thus, the phase plate 705, which has been arranged at the plane P705 in the case of the scanning-type observation apparatus 2, is incorporated into the light capturing lens 451 in such way as to contain the pupil plane P451. In line with that, the relay unit 60 and the relay lenses 702 and 704 of the first detection unit 70 (phase-difference detection unit) are removed. The annular portion (a portion through which straight line in the specimen 501 passes) of the phase plate 705 incorporated into the light capturing lens 451 in the scanning-type observation apparatus 3 approximately coincides with an image of the annular portion (a portion through which light emitted from the LED 101 passes) of the ring slit 103 of the first emission optical system 10 (phase-difference light source unit). Thus, the annular portion of the phase plate 705 is designed in such a way as to contain an image at the pupil plane P451 of the annular portion of the ring slit 103. Accordingly, the light capturing lens 451 to be used in the scanning-type observation apparatus 3 can be an objective lens for a phase-contrast microscope. However, the outputs of the pulse lasers 201 and 211 are adjusted in such a way as to prevent the phase plate 705 from being damaged by absorbing both pump light and Stokes light.

As described above, in the scanning-type observation apparatus according to the third embodiment of the present disclosure, since a phase-contrast microscope objective lens is able to be used for the light capturing lens 451, it is possible to reduce optical systems following the light capturing lens 451 and leading to the photodetector 701. Therefore, it is possible to facilitate optical path adjustment and thus improve the stability of the scanning-type observation apparatus.

### Fourth Embodiment

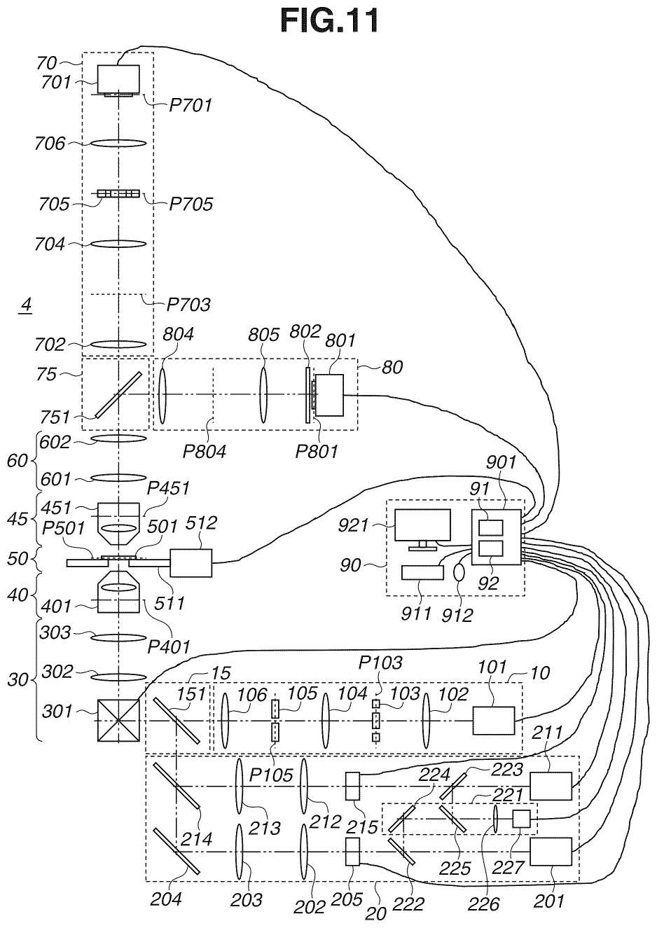

A configuration of a scanning-type observation apparatus according to a fourth embodiment of the present disclosure is described with reference to FIG. 11. FIG. 11 is a schematic diagram illustrating a configuration of the scanning-type observation apparatus 4 according to the fourth embodiment. The scanning-type observation apparatus 4 has the same configuration as that of the scanning-type observation apparatus 2 in the second embodiment except for portions described below. Therefore, constituent elements which are in common with those in the second embodiment are assigned the respective same reference numerals as those in the second embodiment and any duplicate description thereof is omitted here.

The scanning-type observation apparatus 4 illustrated in FIG. 11 includes, instead of the beam block 806, a second detection unit 80 (SRS detection unit). Thus, the scanning-type observation apparatus 4 has, in addition to the function of indirectly detecting a stimulated Raman process by SRP, the function of directly detecting SRS. Thus, the scanning-type observation apparatus 4 is able to provide a Raman signal or Raman image as not only an SRP signal or SRP image but also an SRS signal or SRS image. Moreover, the scanning-type observation apparatus 4 is able to simultaneously acquire a phase-difference image and an SRS image which have the same field of view. Moreover, the control unit 90 of the scanning-type observation apparatus 4 is also electrically connected to the second detection unit 80 (SRS detection unit). The second detection unit 80 receives the other component included in secondary light guided by the wave dividing unit 75 and thus detects a third signal corresponding to a non-linear optical effect occurring at the specimen 501 due to irradiation of the second light.

### [Objective Lens]

It is desirable that the objective lens 401 and the objective lens 451 of the scanning-type observation apparatus 4 have the respective numerical apertures equal to each other. This enables preventing or reducing an artifact which becomes superimposed on an SRS image and an SRS spectrum to be acquired.

### [Second Emission Optical System]

When detecting SRS, the photoacoustic modulators 205 and 215 of the scanning-type observation apparatus 4 modulate, by a specific frequency, the intensity of any one of pulse light fluxes emitted by the pulse lasers 201 and 211, and allow the other pulse light flux to simply pass through the corresponding photoacoustic modulator. Furthermore, in the scanning-type observation apparatus 4, one of the photoacoustic modulators which does not apply intensity modulation to pulse light at the time of SRS detection can be omitted. In the case of such a device configuration, SRP on or SRP off at the time of SRP detection is performed by turning-on or turning-off of the photoacoustic modulator which has not been omitted.

### [Second Detection Unit]

The second detection unit 80 (SRS detection unit) includes relay lenses 804 and 805, a bandpass filter 802, and a photodetector 801. The relay lenses 804 and 805 enlarge or reduce the beam diameter thereof of an incident light flux in such a manner that the beam diameter thereof is suitable for the size of a light receiving surface of the photodetector 801. Between the relay lenses 804 and 805, a plane P804 conjugate to the focal plane P501 of the light capturing lens 451 of the second objective lens 45 exists. The light receiving surface of the photodetector 801 is arranged at a position conjugate to the pupil plane P451 of the light capturing lens 451. The bandpass filter 802 has wavelength characteristics which transmit therethrough only pulse light being one of pump light and Stokes light which is not subjected to intensity modulation by the photoacoustic modulator 205 or 215, and is arranged between the relay lens 805 and the photodetector 801. The photodetector 801 includes, for example, a photodiode. The control unit 90 acquires an SRS signal by performing lock-in detection on a modulated component of the intensity of pulse light received by the photodetector 801. The image generation unit 92 performs imaging based on scan information 30i concerning the scanning unit 30 and a third signal (SRS signal) received from the photodetector 801 of the second detection unit 80, and thus generates a non-linear optical effect image (SRS image).

### [Control Unit]

In the control unit 90 of the scanning-type observation apparatus 4, a lock-in amplifier which detects a modulated component of the light intensity detected by the photodetector 801 is also included in the control device 901. The control device 901 of the scanning-type observation apparatus 4 is electrically connected to the photodetector 801. The control device 901 calculates an SRS signal intensity (simply also referred to as an “SRS intensity”) based on a signal output from the photodetector 801, generates data for respective pixels based on a control signal for the two-axis scanner 301, and thus generates an SRS image. In addition, the control device 901 is also able to generate a phase-difference image and an SRS image based on respective signals which the photodetector 701 and the photodetector 801 have output at the same time frame. At this time, the control unit 90 reads out the phase-difference signal and the SRS signal at the same pixel rate, converts the read-out phase-difference signal and SRS signal into the respective luminances, and thus generates images with the same number of pixels. The control unit 90 stores the generated phase-difference image and SRS image in a storage device (not illustrated) of the control device 901 or outputs the generated phase-difference image and SRS image to the display 921.

### [Observation Processing Flow]

Comparing a phase-difference observation, an SRS observation, and an SRP observation with each other, the phase-difference observation is able to acquire a form image of the specimen 501 at high speed with use of weak illumination light. On the other hand, the SRS observation and the SRP observation require strong pulse light irradiation but are able to acquire a Raman image which provides molecular information. Comparing the SRS observation and the SRP observation, while an SRS image is able to be acquired at higher speed, an SRP image is more time-consuming for acquisition but is higher in detection sensitivity (is able to obtain a higher signal-to-noise ratio than averaging SRS signals for the same amount of time).

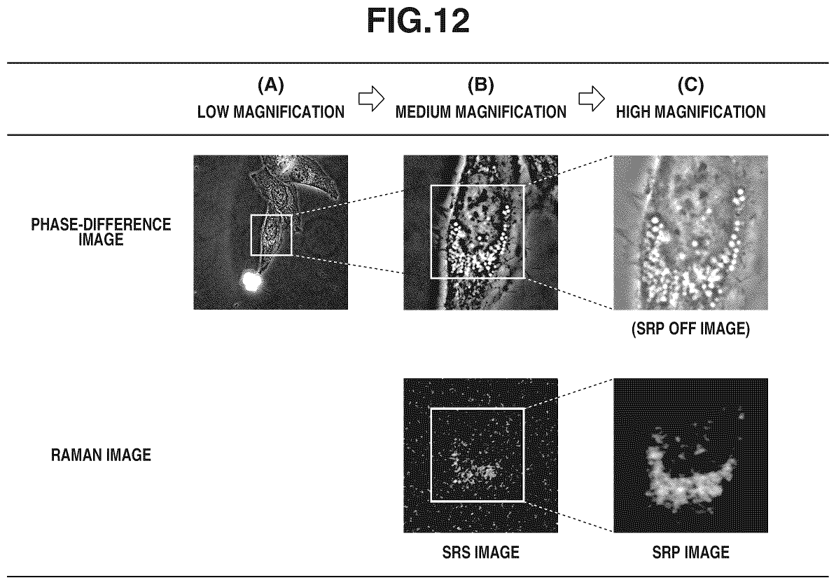

FIG. 12 is a diagram illustrating an observation processing flow using the scanning-type observation apparatus 4 according to the fourth embodiment. Based on the above-described respective observation methods, the scanning-type observation apparatus 4 is able to perform, for example, the following observation processing flows (A) to (C):
(A) finding out a region of interest R504 by a low-magnification phase-difference observation; (B) promptly comparing and checking a phase-difference image and a Raman image by a simultaneous observation of a phase difference and high-speed SRS at a medium magnification; and (C) performing a simultaneous observation of a phase difference and high-sensitivity SRP at a high magnification as needed according to a spatial distribution of SRS intensity and a signal-to-noise ratio.

As described above, the scanning-type observation apparatus according to the fourth embodiment of the present disclosure is also able to generate not only an SRP image but also an SRS image as a primary image of a Raman image made consistent in image quality with a phase-difference image. Since the operator is able to select, according to a region of interest R504 in the specimen 501, between an SRS observation, which is high-speed, and an SRP observation, which is high-sensitivity, the observation efficiency can be increased.

In the above-described scanning-type observation apparatuses 1 to 4, a separation unit can be formed by the control unit 90 or by the wave dividing unit 75 and the control unit 90. Moreover, an image generation unit and a display unit can be formed by the control unit 90. Additionally, a detection unit can be formed by the first detection unit 70 (phase-difference detection unit) or by the first detection unit 70 (phase-difference detection unit) and the second detection unit 80 (SRS detection unit). Phase-difference illumination light may be referred to as “first light”, and pump light and Stokes light may be referred to as “second light”. Phase-difference illumination light which has exited the specimen 501 (straight light and diffracted light) or phase-difference illumination light, pump light, and Stokes light which have exited the specimen 501 may be referred to as “secondary light”. A signal which affords an SRP intensity may be referred to as a “first signal”, a signal which affords an SRP off intensity may be referred to as a “second signal”, and a signal which affords an SRS intensity may be referred to as a “third signal”.

While various embodiments of the present disclosure have been described above, the technical scope of the present disclosure is not limited to a scope described in the above-described embodiments. It is apparent by a person skilled in the art that various alterations or refinements can be added to the above-described embodiments. It is apparent from the description of claims that configurations with such alterations or refinements added thereto can also be included in the technical scope of the present disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-201550 filed Nov. 19, 2024, which is hereby incorporated by reference herein in its entirety.

What is claimed is:

1. A scanning-type observation apparatus comprising:
a first emission optical system configured to emit first light including a spatially modulated component;
a second emission optical system configured to emit second light coherently and temporally modulated;
a wave combining unit configured to wave-combine the first light and the second light;
a scanning unit configured to synchronously scan the first light and the second light which have been wave-combined;
a condensing lens configured to condense each of the first light and the second light which have been scanned;
a placement unit configured to allow a specimen to be placed at a light condensing position of the condensing lens;
a light capturing lens located on a side opposite to the condensing lens across the placement unit and configured to capture secondary light received from the specimen;
a detection unit configured to detect the secondary light captured by the light capturing lens;
a separation unit configured to temporally demodulate a signal received from the detection unit and to separate the demodulated signal into a first signal corresponding to a non-linear photothermal effect having occurred at the specimen by irradiation of the second light and a second signal which does not contain the non-linear photothermal effect; and
an image generation unit configured to generate an image based on scan information concerning the scanning unit and at least one of the first signal and the second signal.

2. The scanning-type observation apparatus according to claim 1, wherein the wave combining unit coaxially wave-combines the first light and the second light.

3. The scanning-type observation apparatus according to claim 1, wherein the scanning unit coaxially scans the first light and the second light.

4. The scanning-type observation apparatus according to claim 1, wherein the condensing lens coaxially condenses each of the first light and the second light.

5. The scanning-type observation apparatus according to claim 1, wherein the condensing lens and the light capturing lens have a portion in which respective depths of focus of the condensing lens and the light capturing lens overlap in an optical axis direction.

6. The scanning-type observation apparatus according to claim 1, wherein the second emission optical system includes a pair of pulse light sources configured to emit a pair of pulse light trains different in oscillation wavelength and synchronous with each other.

7. The scanning-type observation apparatus according to claim 6, wherein each of the pulse light sources includes a modulation unit configured to periodically modulate an intensity of at least one of the pair of pulse light trains.

8. The scanning-type observation apparatus according to claim 6, wherein each of the pair of pulse light trains includes a Stokes light train and a pump light train which exert a non-linear optical effect to the specimen.

9. The scanning-type observation apparatus according to claim 1, wherein the first emission optical system includes a first light source configured to emit incoherent light with a predetermined waveform.

10. The scanning-type observation apparatus according to claim 1, wherein the first emission optical system includes a modulation optical system configured to annularly modulate an intensity component of the first light, and the detection unit includes a demodulation optical system having an annular portion which demodulates an intensity component and a phase component of the secondary light.

11. The scanning-type observation apparatus according to claim 1, wherein the first emission optical system includes a pinhole configured to block a part of the condensed first light.

12. The scanning-type observation apparatus according to claim 1, wherein the first emission optical system includes a modulation optical system having an annular portion which modulates an intensity component and a phase component of the first light, and the detection unit includes a demodulation optical system which annularly demodulates an intensity component of the secondary light.

13. The scanning-type observation apparatus according to claim 1, further comprising a wave dividing unit configured to perform division in such a way as to guide a part of the secondary light captured by the light capturing lens to the detection unit and not to guide the other part of the secondary light to the detection unit.

14. The scanning-type observation apparatus according to claim 13, further comprising a second detection unit configured to receive the other part of the secondary light guided by the wave dividing unit and to detect a third signal corresponding to a non-linear optical effect having occurred at the specimen by irradiation of the second light.

15. The scanning-type observation apparatus according to claim 14, wherein the image generation unit performs imaging based on scan information concerning the scanning unit and the third signal.

16. The scanning-type observation apparatus according to claim 13, further comprising, on an optical path between the wave dividing unit and the light capturing lens, a reverse scanning unit configured to perform reverse scanning in synchronization with the scanning unit.

17. The scanning-type observation apparatus according to claim 16, wherein the detection unit includes a pinhole configured to block a part of the secondary light and a pair of relay lenses arranged across the pinhole.

18. The scanning-type observation apparatus according to claim 1, further comprising a display unit configured to display an image obtained by the image generation unit performing imaging.

19. The scanning-type observation apparatus according to claim 18, further comprising an input unit configured to receive inputting of information concerning a region of interest from an operator based on the image displayed on the display unit, and a scan condition acquisition unit configured to acquire a scan condition for the scanning unit based on the received information concerning the region of interest.

20. The scanning-type observation apparatus according to claim 19, further comprising a scan condition determination unit configured to, based on the acquired scan condition, determine a scan condition for a time of image capturing for the scanning unit.

21. The scanning-type observation apparatus according to claim 20, further comprising an updating unit configured to display the scan condition acquired by the scan condition acquisition unit on the display unit and to receive updating of the scan condition.
